(19) United States
(12) Patent Application Publication
(10) Pub. No.: US 2021/0272206 A1
(43) Pub. Date: Sep. 2, 2021

(54) Financial Recommendation Engine

(71) Applicant: Afford It Technology, LLC, Tampa, FL (US)

(72) Inventors: Kevin O'Brien, Tampa, FL (US); Thomas Seeley, Tampa, FL (US); Sidharth Anandkumar, Tampa, FL (US); William O'Donnell, Safety Harbor, FL (US)

(73) Assignee: Afford It Technology, LLC, Tampa, FL (US)

(21) Appl. No.: 17/323,669

(22) Filed: May 18, 2021

Related U.S. Application Data
(63) Continuation-in-part of application No. 16/134,032, filed on Sep. 18, 2018.

(51) Int. Cl. G06Q 40/06; G06Q 40/02

(52) U.S. Cl. CPC G06Q 40/06; G06Q 40/025

(57) ABSTRACT

A recommendation engine analyzes an entity's financial situation and, if possible, makes recommendations that, if accepted, will move the entity's financial state into one in which, for example, a loan will be approved. In some embodiments, the recommendation engine analyzes an entity's financial situation and, if possible, makes recommendations that generally improve the financial state of the entity. In one embodiment, recommendations include reduce existing debt, using existing assets for equity, looking at co-borrowers and whether a co-borrowers is in a better financial state, using a portion of a down payment to pay down existing debts, consolidate debt to low rate credit cards, etc.

### FIELD

This invention relates to the field of finances and more particularly to a system for using an internal scoring mechanism within a recommendation engine to provide actionable financial options.

### BACKGROUND

People and businesses often have a complicated collection of assets and liabilities such as liquid assets e.g. (savings, checking, bonds, retirement funds, money markets, CDs, etc.), non-liquid assets e.g. (plots of land, owned homes, vehicles, etc.), and liabilities e.g. (lines of credit, HELOCs, mortgages, student loans, personal loans, etc.). These people and businesses, henceforth referred to as entities, have a vast number of options for improving their financial position due to the myriad of financial products and complex requirements associated with those products. Due to this, finding solutions which put them in a better financial position is oft an overwhelming and miring task. For example, if one has a liability such as a credit card balance on which she is paying 17% interest but has an asset as an equity in a motor vehicle on which a lower rate auto loan exists (e.g. 5%). It is possible that the auto can be modified to extract some equity and using proceeds partially pay off credit card debt and transfer remaining credit card debt to a 0% 12-month introductory rate credit card, while the remaining auto loan balance can be refinanced to the lower interest auto loan with a shorter loan term. While the financial opportunities aren't inherently difficult to understand, with the sheer number of lenders, assets, liabilities, and refinancing options available to an entity, synthesizing even one liability's options becomes too time consuming without some guidance.

People and businesses apply for loans every day. Lending establishments review loan applications and decide whether the applicant qualifies for the primary loan based upon many different factors. These factors that assess the creditworthiness of an entity are henceforth referred to as risk metrics. One primary metric that is used by many or all lending establishments is debt-to-income ratio. The debt-to-income ratio is a calculation of the portion of a person's, families', or business's income that is allocated to paying off debt.

Acceptable debt-to-income ratios vary based upon lending establishments, as some lending establishments are willing to take on more risk (e.g. they are willing to lend to those with a higher debt-to-income ratio). Debt-to-income ratio has been demonstrated as a good measurement of a loan recipient's ability to repay a loan. As one might imagine, if a loan recipient's debt-to-income ratio is close to 100%, it would be almost impossible for that entity to pay back their debts as the entity also needs money for other reasons; in the case of a person, money is needed for transportation, food, housing, and in the case of a business, money is needed for operating costs.

The debt-to-income ratio considers all loans/debts of the applicant, typically through review of one or more credit reports pulled by the lender. One example is a couple seeking to obtain a mortgage loan. The lender pulls a credit report for both applicants and finds that both are repaying student loans, one having $3,000 due with payments of $100.00 per month and the other having $1,000 due with payments of $200.00 per month. The lender also finds that there is a car loan with payments of $200.00 per month. The couple has a total income of $81,600.00 per year, or $6,800.00 per month. This couple seeks to buy a home in the amount of $225,000.00. Having a $25,000.00 down payment, the couple plans to obtain a 30-year mortgage loan in the amount of $200,000.00. At current interest rates would require payments of $1,200.00 per month. Therefore, this couple having $6,800.00 per month in income will have $1,700.00 ($100.00+$200.00+$200.00+$1200.00) in loan payments per month, or a debt-to-income ratio of 25%. In this case, the lender finds the debt-to-income ratio acceptable and approves the loan.

In another example like the above, the same couple has the same existing student and car loans and seeks the same mortgage loan, but the couple earns less, having a total income of $40,800.00 per year, or $3,400.00 per month. The interest payment of $1,700.00 in loan payments per month, if approved, will increase this couple's debt-to-income ratio to around 50%. Most lenders will not approve a loan with such a high debt-to-income ratio, and, therefore, this loan is not approved. The couple receives a letter simply stating that their loan is not approved. The loan originator does not look for alternatives.

In the above example, if the couple reallocated some of their down payment to pay off their student loans, the total mortgage amount would increase by $4,000.00 to $204,000.00, and the monthly mortgage payments would increase slightly to $1,224 and the total monthly payments would be $1,424.00 ($200.00+$1,224.00) instead of $1,700.00. This reduces the couple's debt-to-income ratio from 50% to around 34%, which is then acceptable, and their loan is likely approved by the lender.

This is but a simplified example. There are countless possible alternatives for even such a simple problem and each alternative has a short life-span as refinance opportunities are often limited to a fixed supply, interest rates change daily or hourly, investment opportunities are of limited availability and change frequently, etc. Further, given the sheer number of possible alternatives, it is impossible for a human mind to calculate all or most alternative solutions that will improve one's financial situation and just as impossible to rank such possible alternatives to determine an actionable solution before any of the solution basis change (e.g. interest rates change, specific loans are no longer available . . . ).

What is needed is a system that will synthesize countless combinations of financial data, lender options, assets, and debts to rank a large number of possible options into one or more actionable solutions that, if acted upon, will improve a financial position.

### SUMMARY

The disclosed recommendation engine analyzes the entity's financial situation and, if possible, makes recommendations that, if accepted, will move the entity's financial state in a positive direction, for example, into a financial position in which a sought-after loan will likely be approved, regardless if the loan would have been approved in the first place. Although many possible uses of the disclosed system are anticipated, a few examples are looking for refinancing options to reduce existing debt, looking to existing assets for equity, looking to see if there are co-borrowers and whether one of the co-borrowers is in a better financial state and can obtain the loan without the other co-borrower, using parts of a down payment to partially pay off some existing debts, consolidate debt to low or 0% introductory rate credit cards, etc.

There exists an incalculable number of potential financial steps that can be suggested to determine one or more solutions that will improve an entity's financial state. Consider the myriad of loans available, the myriad of investment choices, and the number of permutations of allocation of available assets/capital. The access to information needed in order to assess the validity of each potential solution and analyze the performance of these potential solutions would prevent an individual person from performing this process mentally. For example, to know which refinancing option for a mortgage is best across many financial institutions, one would need to have instantaneous knowledge of all of the mortgage products available in every financial institution at the current time. Without the disclosed automation, any manually obtained solutions will not take into account as many potential solutions as possible and such manually obtained solutions will likely expire before the entity acts on any solution as by the time a manual mental process completes, one or more of the initial solutions are likely invalid, for example, due to fluctuations in mortgage availability and interest rates.

In another embodiment, a use of the recommendation engine is disclosed including obtaining data regarding the desired loan, the data including a loan amount, obtaining financial data for the entity, and obtaining at least one credit report for the entity. From these, a score is calculated for the requestor from the financial data and the data regarding the desired loan. Then the data is supplied to the recommendation engine, which in turn searches for possible outcomes improving this score. The alternative solutions are proposed to the entity who in turn can use them before seeking the desired loan, where without the recommendations they would have been denied.

In another embodiment the recommendation engine is used to analyze an entity's current financial portfolio, without needing a requesting loan. On a regular schedule or executed manually, the recommendation engine is fed the financial data of an entity and finds optimal alternatives to the entity's current debt and investments in the entity's current financial portfolio.

In another embodiment, the described system is operated by a financial institution that offers such loans or by a third party. The operator, henceforth referred to as the user, will perform the same or similar steps, except it will find a financial institution that matches the loan requested by the entity.

In another embodiment, the described recommendation engine is made directly available to the entity and the entity becomes the user of the system.

In another embodiment, a use of the system surrounding the recommendation engine is disclosed including a computer and a plurality of data sources that are accessible by the computer. The plurality of data sources includes at least a credit reporting agency and a lender (e.g. loan rates, etc.). Software that runs on the computer inputs and stores financial data regarding the entity from a user interface and/or from any or all data sources. The software that runs on the computer inputs and stores data regarding a desired loan. The software that runs on the computer calculates a baseline score for the entity from the financial data and the data regarding the desired loan. The software executes the recommendation engine and proposes the alternative solutions to the entity.

In one embodiment, a method of creating financial recommendations using a recommendation engine is disclosed. The method includes obtaining data regarding a desired loan for an entity which includes a loan amount, obtaining financial data for the entity and obtaining a credit report for the entity. A a set of instruments that are currently available from institutions (e.g., loans, credit cards) are obtained. If a debt-to-income ratio for the desired loan is less than a maximum debt-to-income ratio, the desired loan is approved. Otherwise, financial recommendations are generated for the entity using the financial data, the credit report, and the set of instruments. The financial recommendations are then sorted into a set of top financial recommendations and for each recommendation in the set of the top financial recommendations, if a current one of the set of the top financial recommendation reduces the debt-to-income ratio for the desired loan to less than the maximum debt-to-income ratio, that financial recommendation is recommended to the entity, and if the entity accepts and implements any recommendation, the desired loan is approved.

In another embodiment, a system for making financial recommendations is disclosed. The system includes a computer that has access to a plurality of data sources which include a credit reporting agency and a lender. Software running on the computer receives financial data regarding an entity and stores the financial data in a memory of the computer. The financial data is from the entity and/or from any or all of the data sources. The software receives data regarding a desired loan including a loan amount and stores the data regarding the desired loan. The software calculates a debt-to-income ratio for the entity from the financial data and the data regarding the desired loan and if debt-to-income ratio for the entity is less than a maximum debt-to-income ratio, the software provides approval for the desired loan and ends. Otherwise, the software generates alternative solutions that will reduce the debt-to-income ratio to a value that is less than the maximum debt-to-income ratio. If there are no alternative solutions that reduce the debt-to-income ratio to the value that is less than the maximum debt-to-income ratio, the software rejects the desired loan and ends. Otherwise, the software sorts the alternative solutions and reports the alternative solutions that best improve the debt-to-income ratio into a list of recommended alternative solutions and the software presents the list of recommended solutions to the entity. If the entity accepts and implements one of the recommended alternative solutions from the list of recommended alternative solutions, the software approves the desired loan and ends. If the entity rejects the alternative solutions, the software denies the desired loan and ends.

In another embodiment, a system for making financial recommendations is disclosed. The system includes a computer that has access to data sources that include at least a credit reporting agency and a lender. Software running on the computer receives financial data regarding an entity and stores the financial data in a memory of the computer. The financial data is from the entity and/or from any or all of the plurality of data sources. The software generates a set of alternative solutions that will improve finances of the entity; and sorts the set of the alternative solutions to report a subset of the set of the alternative solutions that best improves the finances of the entity.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system for improving a entity's financial position.

FIG. 2 illustrates a schematic view of a computer as used by the system for offering recommendations and/or performing actions to improve an entity's financial position.

FIGS. 3, 3A, and 4-6 illustrate exemplary financial data input and data collection processes of the financial recommendation engine.

FIG. 7 illustrates a sample program flow for prior systems for originating a loan. Prior loan origination is the process of an entity applying for the loan and receiving an approval or denial decision.

FIG. 8 illustrates a simplified program flow for the system for improving an entity's financial position.

FIGS. 9 through 14 illustrate detailed sample program flows for the system for improving an entity's financial position.

FIG. 15 illustrates the generation of options for each tradeline (e.g. each debt).

FIG. 16 illustrates the generation of a plurality of combinations of the options generated in FIG. 15.

FIG. 17 illustrates the scoring and ranking of the combinations generated in FIG. 16.

FIG. 18 illustrates details of the scoring of FIG. 17.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “primary loan” represents any loan that might be sought such as an automobile loan, mortgage, personal loan, etc. Throughout this description, the term “user” refers to a person or persons that interface with the financial recommendation engine on behalf of themselves or others. The term “lender” refers to a financial institution that may or may not provide the primary loan. Throughout this document, the term “entity” refers to the person, persons, or institutions seeking to improve their financial position, and, in some embodiments, the entity is also the user.

Throughout this description, various types of loans are described as examples (e.g. vehicle loans, student loans, mortgages) and these are meant to be examples as there is no limitation on the types of loans that the entity currently has outstanding, nor the types of loans sought.

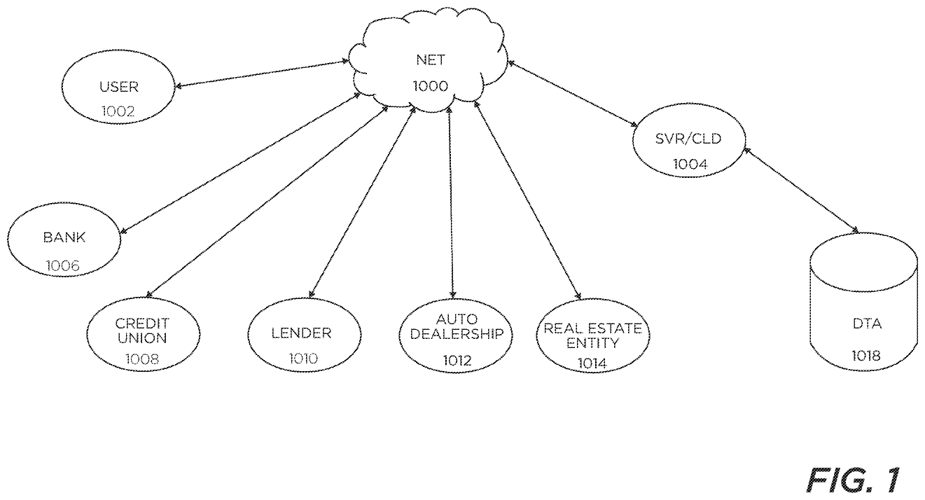

Referring to FIG. 1 illustrates a data connection diagram of the system. In this example, one or more user devices 1002 communicate through the wide area network 1000 (e.g. the Internet) to a server computer 1004. That which is shown in FIG. 1 is an exemplary connection layout and is in no way limiting as other networking configurations are anticipated as known in the art.

The server computer 1004 has access to a data storage 1018. The server computer 1004 transacts with the user devices 1002 through the network 1000 to present menus to/on the user devices 1002, obtain inputs from the user devices 1002, and provides data to the user devices 1002. In some embodiments, login credentials (e.g. passwords, pins, secret codes) are stored local to the user devices 1002; while in other embodiments, login credentials are stored in a data storage 1018 (preferably in a secured area) requiring a connection to login.

The server computer 1004 has access to a plurality of data sources 1006/1008/1010/1012/1014, including but not limited to banks 1006, credit unions 1008, lenders 1010, auto dealerships 1012, and real estate organizations 1014 for obtaining information that is used by the recommendation engine to find recommendations that are best suited to move the entity in a better financial position. The data sources provide. In this example, the one or more data sources 1006/1008/1010/1012/1014 include one or more lenders 1010 (note that in some embodiments, the server computer 1004 is part of a lender 1010 and therefore, connected locally). In this example, the plurality of data sources 1006/1008/1010/1012/1014 also include but are not limited to banks 1006, one or more credit unions 1008, private lenders 1010, auto dealerships 1012, and real estate organizations 1014. An example of a real estate entity would be a home value appraisal site or publicly available property information.

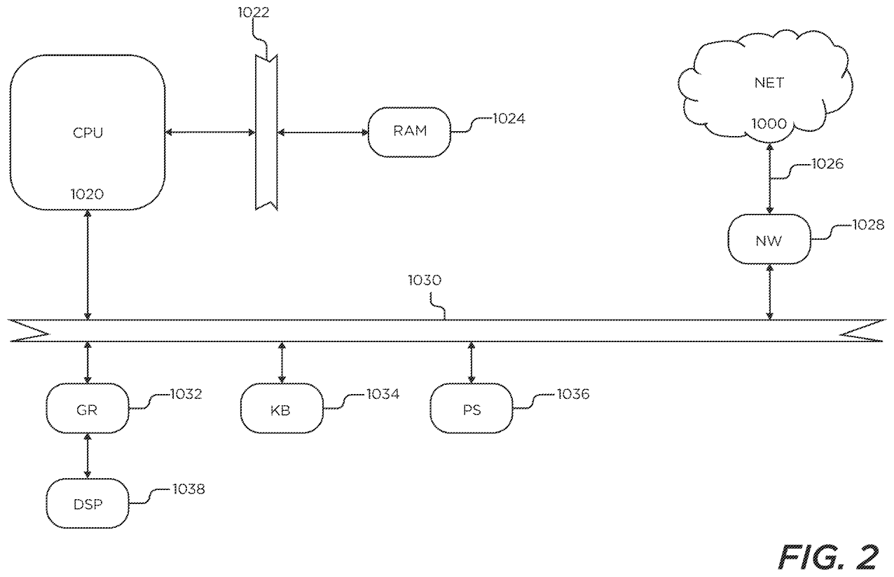

Referring to FIG. 2, a schematic view of a typical computer system (e.g. server computer 1004 or user devices 1002) is shown. The example computer system represents a typical computer system used for back-end processing, calculating financial models, generating reports, displaying data, etc. This exemplary computer system is shown in its simplest form. Different architectures are known that accomplish similar results in a similar fashion and the present invention is not limited in any way to any computer system architecture or implementation. In this exemplary computer system, a processor 1020 executes or runs programs in a random-access memory 1024. The programs are generally stored within a persistent memory 1036 and loaded into the random-access memory 1024 when needed. The processor 1020 is any processor, typically a processor designed for computer systems with any number of core processing elements, etc. The random-access memory 1024 is connected to the processor, for example, by a memory bus 1022. The random-access memory 1024 is any memory suitable for connection and operation with the selected processor 1020, such as but not limited to SRAM, DRAM, SDRAM, RDRAM, DDR, DDR-2, etc. The persistent memory 1036 is any type, configuration, capacity of memory suitable for persistently storing data, for example, magnetic storage, flash memory, read only memory, battery-backed memory, etc. The persistent memory 1036 is typically interfaced to the processor 1020 through a system bus 1030, or any other interface as known in the industry.

Also shown connected to the processor 1020 through the system bus 1030 is a network interface 1028 (e.g. for connecting to a data network 1000 through a connection 1026), a graphics adapter 1032 and a keyboard interface 1034 (e.g. Universal Serial Bus—USB). The graphics adapter 1032 receives commands from the processor 1020 and controls what is depicted on a display image on the display 1038. The keyboard interface 1034 provides navigation, data entry, and selection features.

In general, some portion of the persistent memory 1036 is used to store programs, executable code, data, contacts, and other data, etc.

The peripherals are examples and other devices are known in the industry such as speakers, microphones, USB interfaces, Bluetooth transceivers, Wi-Fi transceivers, image sensors, mouse inputs, etc., the details of which are not shown for brevity and clarity reasons.

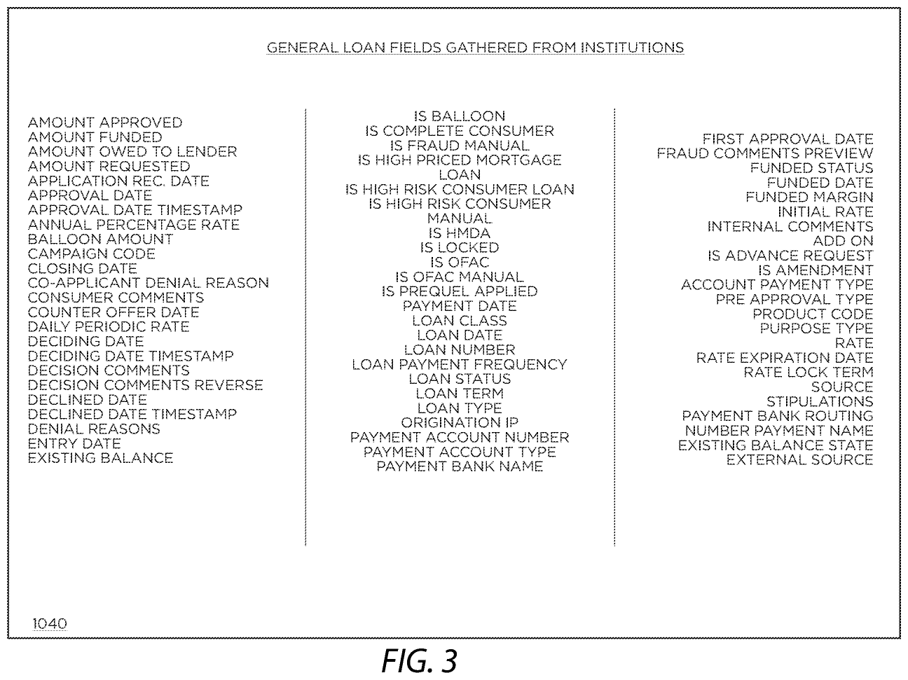

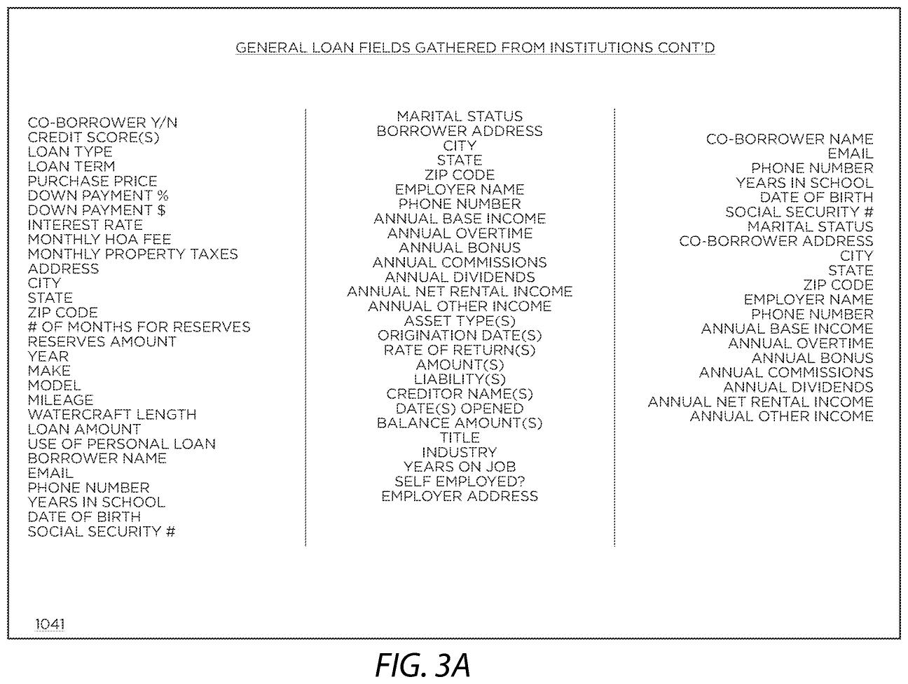

Referring to FIGS. 3-6, sample financial data input interfaces 1040/1041/1042/1044/1046 of the recommendation engine is shown.

FIGS. 3 and 3A show sample of instruments by loan fields 1040/1041 gathered from institutions that are currently available and are obtained from the plurality of data sources 1006/1008/1010/1012/1014, for example, available mortgages, automobile loans, home-equity loans, personal loans, secured loans, investment mechanisms (e.g. CD rates, minimum to invest), etc.

Referring to FIGS. 3 and 3A, examples of the financial data received from financial institutions regarding the entity. This data includes, but is not limited to, detailed information on existing loans for the entity(s) such as amount, interest rate, term, type, date, etc.

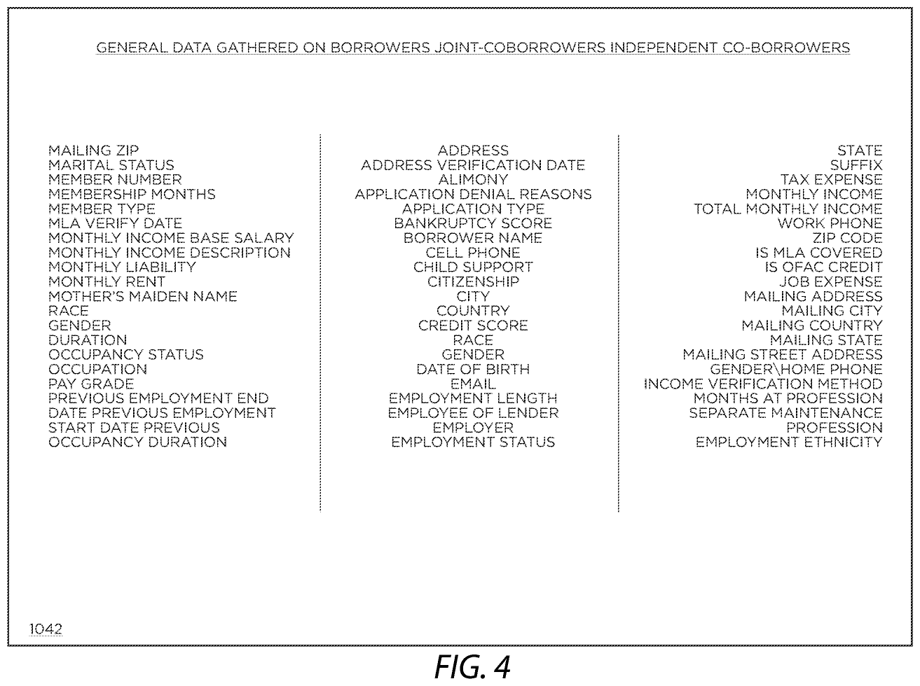

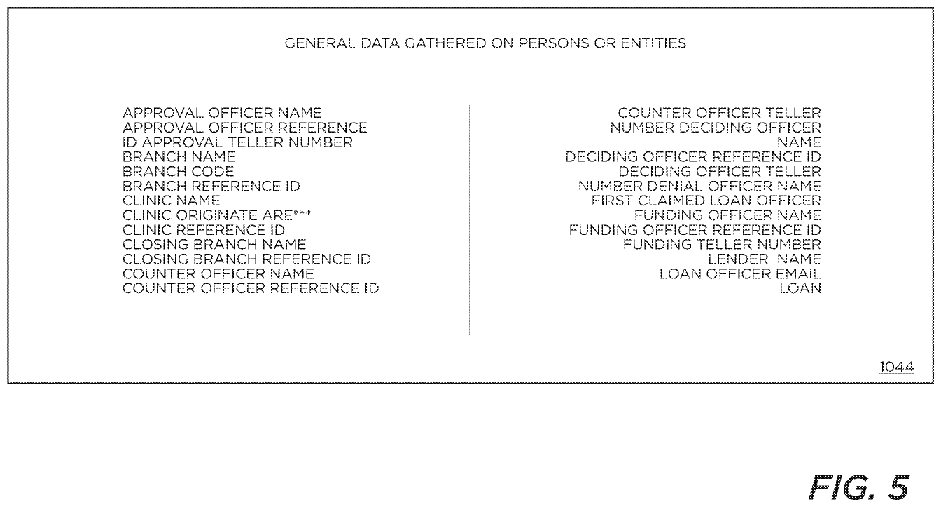

Referring to FIG. 4-5, personal information received on the entity themselves such as name, date of birth, name of company, etc., are shown.

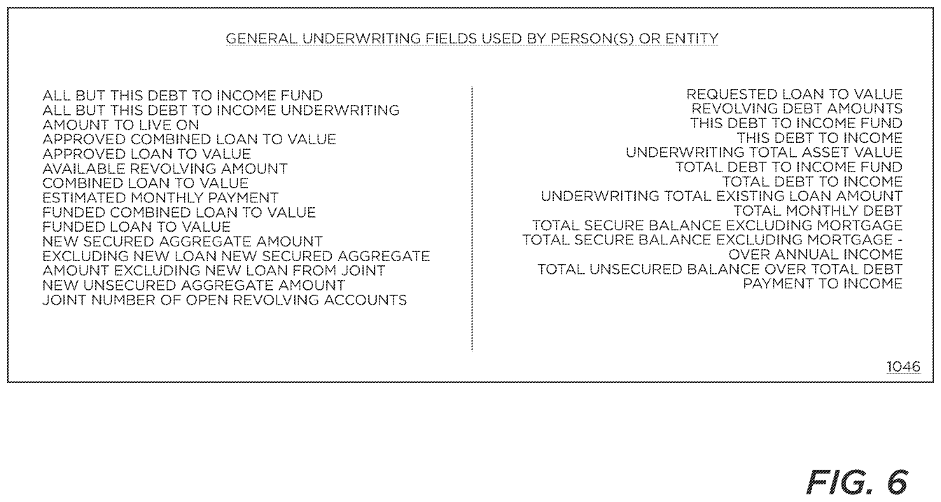

Referring to FIG. 6, additional financial data examples that are relevant are shown. For example, data used in the loan underwriting process during loan origination. Although only two entities are shown, the system for originating loans is not limited to any number of entities as long as there is at least one entity. In addition, it is anticipated that in some embodiments, the entity is an organization instead of a person and, if the entity is an organization, then certain data changes are made. For demonstrative purposes, instead of social security number, a tax ID is obtained. In either case the recommendation engine execution is not predicated on having certain pieces of information.

In some embodiments, imaging and character recognition are used to obtain the data from the entity. For example, an image is captured of the entity's most recent tax returns, credit card statements, bank statements, loan agreements, etc., and the image is analyzed using character recognition and intelligence related to determining what each set of numbers represents. For example, capturing an image of the entity's tax return and recognizing the 10-digit number that is a social security number and 1040 line 37 represents the entity's gross income . . . . In another example, capturing an image of an entity's loan agreement for a vehicle loan then character recognizing and analyzing the loan agreement to extract the principal amount, date of first payment, date of last payment, monthly payment amount and interest rate.

The financial recommendation engine utilizes data from the personal financial profile of the entity(s) to calculate recommendations, and/or perform actions in accordance with the scoring systems (to be described) to present recommendations that will improve an entities financial position.

The financial data inputs 1040/1042/1044/1046 shown in FIGS. 3, 3A, and 4-6 are simplified for clarity and brevity reasons. It is fully anticipated that more or less inputs are provided and that any or all inputs be obtained in any way known in the industry using any data source, any input device, and user interface arrangement, including paper that is later scanned and recognized.

It is also fully anticipated that, in some embodiments, more or less data is entered into the recommendation engine, as it is fully anticipated that more or less data is required and/or some data is automatically obtained from the plurality of data sources 1006/1008/1010/1012/1014. For example, in the financial data 1042 of FIG. 4, monthly income is requested, but in the United States, having the entity's social security number (or last 4 digits of the entity's social security number), name, and address, the entity's gross income is obtainable from the taxation authority of the United States, e.g. the, IRS.

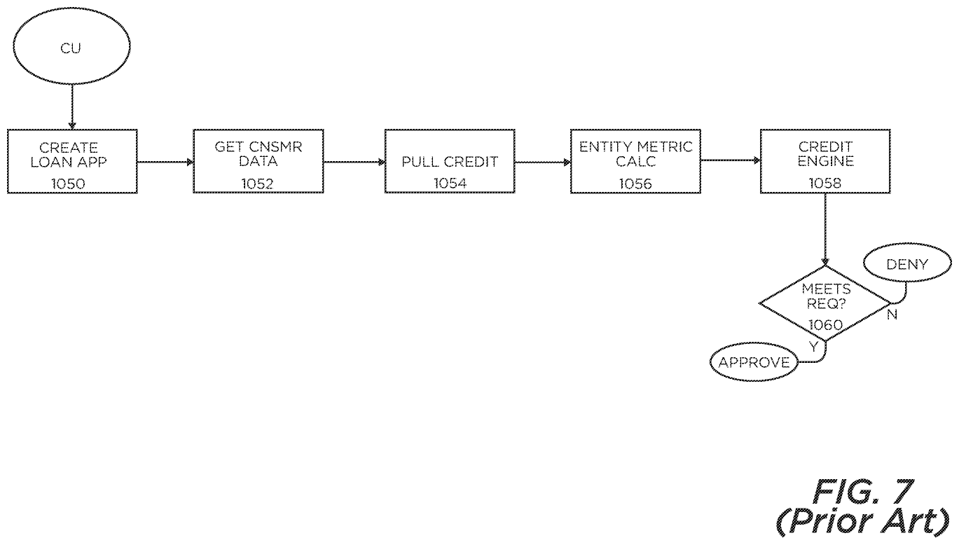

Referring to FIG. 7, a sample program flow of the prior art system for loan origination is shown. To start the loan origination, a loan application is created 1050. Data regarding the entity is captured 1052. Then one or more credit reports are obtained 1054. Next, the financial institution calculates 1056 key metrics used in determining eligibility for the primary loan. These metrics include, but are not limited to, debt-to-income ratio, loan-to-value ratio, total income, occurrences of any bankruptcies or occurrences of liens/judgements against the entity. The metrics are then passed into a decisioning engine 1058 (e.g. a loan officer) that compares the metrics to the product requirements for the loan. If the requirements are met 1060, the loan is approved, otherwise it is denied. In the prior art, no recommendation system is provided and, therefore, no recommendations are provided to the denied entity of any solutions that are available to help the entity to be approved.

As an industry example, if an entity's debt-to-income ratio is over 100%, there would be no way for the entity to pay back the loan, as the loan payments would require more money than the entity's income every month. Therefore, the decision would likely be a denial. Note that, in the described prior art, no suggestions are automatically generated to reduce the entity's debt-to-income ratio to something that is acceptable to the lender.

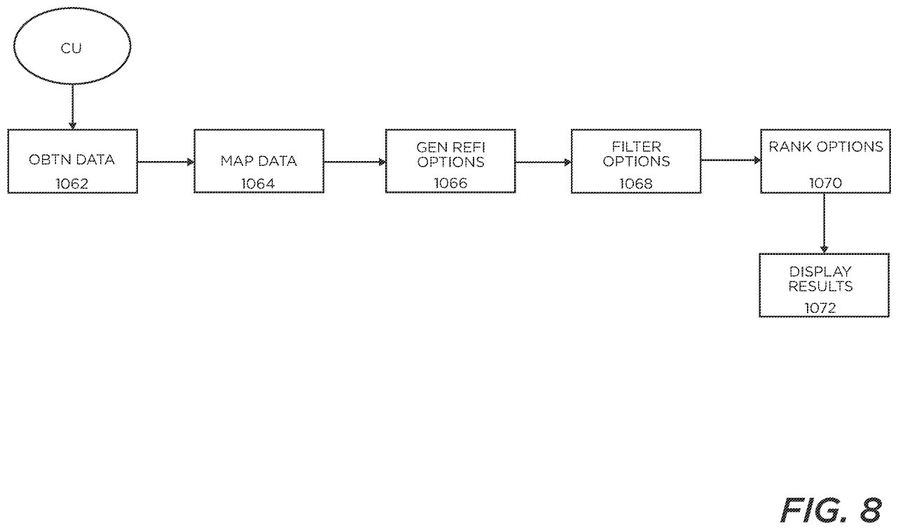

A description of a loan origination using the financial recommendation engine integrated is shown in FIG. 8. Note that there are many uses for the proposed financial recommendation engine inside and outside the context of loan origination, but examples of a loan origination are used to highlight the usefulness of the recommendation engine of the disclosed system.

FIG. 8 shows the process for integrating the financial recommendation engine into the loan origination process. The financial recommendation engine accesses various instruments available (e.g., loans, investments, assets) and financial data of an entity to generate one or more financial recommendations. As there may be a huge number of such financial recommendations, only a set of top financial recommendations are presented to the entity.

The high-level flow chart of FIG. 8 is for illustration purposes and described in brief form to convey the overall operation of the financial recommendation engine as used within a loan origination scenario. One ordinarily skilled in the art of programming and, especially, artificial intelligence, would be capable of making the disclosed systems without undue experimentation.

The server computer 1004 obtains 1062 the financial data 1040/1041/1042/1044/1046 from the plurality of data sources 1006/1008/1010/1012/1014 and/or data inputs. The financial data 1040/1041/1042/1044/1046 data is mapped 1064 to internal formats. In such, the server computer 1004 also obtains 1062 a list of the entity's liabilities, herein called tradelines, as well as a list of the entity's assets.

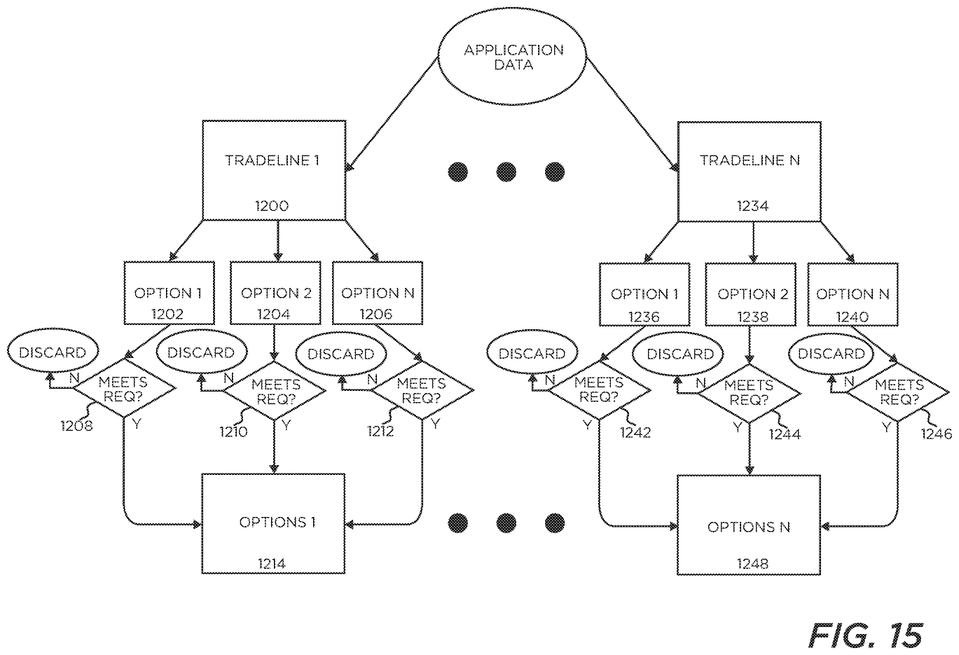

The server then generates 1066 a set of refinancing options for the entity's tradelines (e.g. liabilities) using the financial recommendation engine (see FIG. 15) that searches for one or more of the financial products 1040 that will improve the entity's financial position in view of the loan being sought. For example, if an entity has credit card debt, student loan debt, and a mortgage, then the repository will be searched for every possible way to utilize the entity's available assets and to refinance the credit card, student loan debt, and mortgage using the one or more financial products 1040 that are available.

It is important to note that the suggestion engine also finds solutions that don't involve refinancing into a different product from the financial products 1040. Options such as using available assets to pay off debt in various increments and taking no action with a tradeline are also considered by the suggestion engine. In such, the one or more outputs of the suggestion engine will leave one or more existing debts as-is. The suggestion engine analyzes the entity's assets and the financial products 1040 to determine whether the individual qualifies for each financial product 1040 using the guidelines for that financial product 1040. If the entity is not qualified, that financial product 1040 is filtered out from the list of financial products 1040. If the entity qualifies, that financial product 1040 is added to a list of potential solutions in generating 1066. The list of potential solutions is filtered 1068 to remove certain solutions that are not feasible, are undesirable, or are unreasonable (e.g. selling of an asset such as a motor vehicle). The suggestion engine then ranks 1070 the list of potential refinance options to produce a final list of suggestions and the top-n suggestions are displayed 1072 or sent to the user/entity.

Specific examples of the process followed with different loan types now follow.

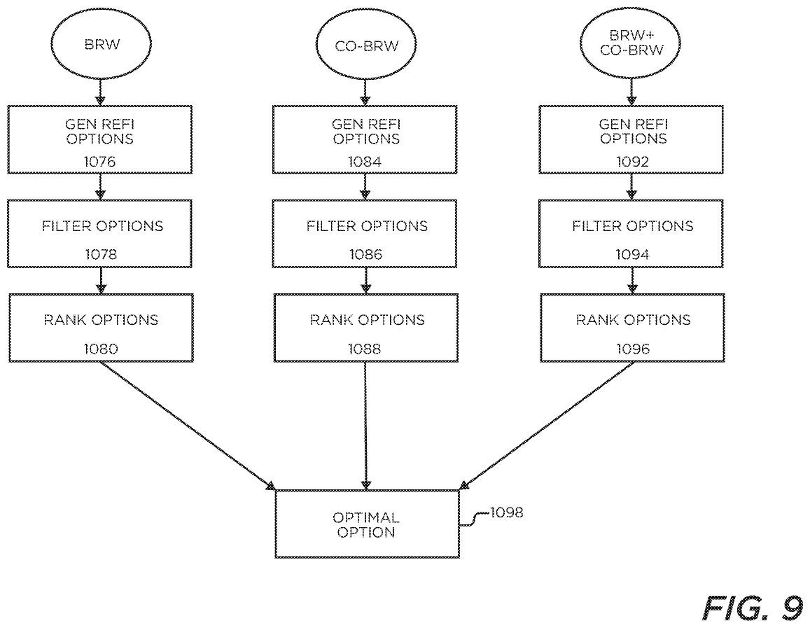

FIG. 9 shows how the system for improving an entity's financial position operates for multiple borrower scenarios. In FIG. 9, options that are generated 1076/1084/1092 for each borrower are the same actions described in the list of potential solutions however are done for each entity in this scenario. One for borrower, one for coborrower and one for the combined borrower and coborrower. Filter options 1078/1086/1094 describe a multi borrower scenario for single borrower filter options 1068 as do the rank options 1080/1088/1096 for single borrower rank options 1070. The optimal solution 1098 shows one additional step before the results are displayed 1072, based on each scenario's filtered result an optimal option can be selected between all scenarios. In FIG. 9, it is determined whether there is a second entity (e.g. co-borrower). When there is a co-borrower, the process described can be computed for every combination of entities. It is possible that the desired loan is possible using only one of the co-borrowers instead of both combined, as one co-borrower often has more income or more debt (payments) than the other co-borrower. Note that FIG. 9 is simplified for two entities, though it is fully anticipated that more than two entities exist for a given loan.

Although shown sequential, there is no required order for this search process. For example, in some embodiments, each alternative path is traversed in parallel. In some embodiments, if an alternative is found regarding one search (e.g. a student loan), there is no need to search for other alternative solutions. Further, even though shown having all searches for solutions performed, even if an earlier search has a workable alternative solution, in some embodiments, once a workable alternative solution is found, that alternative is reported and no further searching is performed.

In the examples of looking for alternative solutions, it is fully anticipated that, in some embodiments, more or less searches are made for alternative solutions are made. For example, some lending institutions are not interested in refinancing a student loan and, therefore, no alternative solution regarding a student loan is sought. As another example, the examples shown look for vehicle loans (e.g. car loan, motorcycle loan) while it is fully anticipated that any type of loan is fair game for analysis, including, but not limited to, a personal loan, a watercraft loan, a jewelry loan, a loan on a second home, etc.

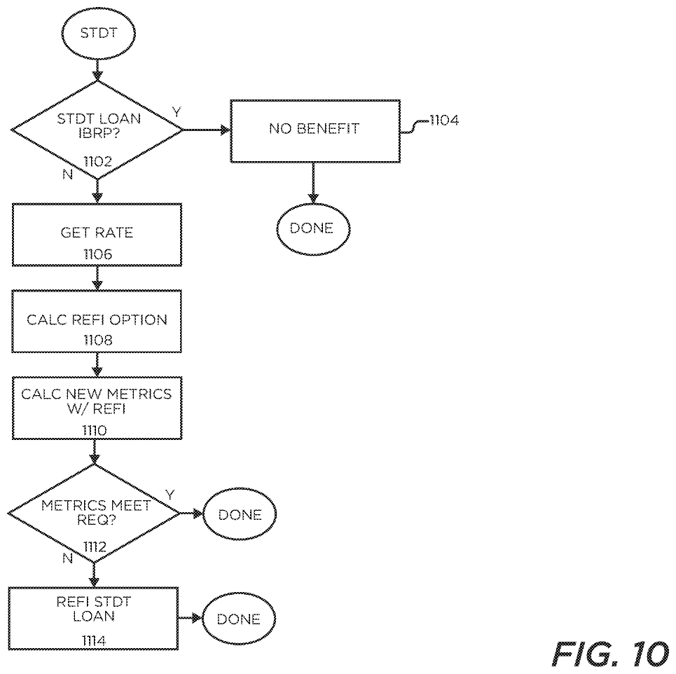

In the example shown in FIG. 10, it has been determined that there is a student loan. The student loan is processed by first checking to see if the student loan is indexed to the entity's earnings 1102. If the student loan is indexed to the entity's earnings 1102 (income-based repayment), no benefit can be obtained 1104 from refinancing the student loan and no solution is recorded.

If the student loan is not indexed to the entity's earnings 1102, a refinance loan rate is obtained from one or more lenders 1106, and a calculation is made 1108 to determine the effect of the refinanced student loan as well as a calculation of new risk metrics 1110 taking into consideration the refinanced student loan. If the new risk metrics will still not result in meeting the requirements 1112 for the primary loan, no benefit can be obtained from refinancing the student loan and no solution is recorded. If the new risk metrics meet the requirements 1112 for the primary loan, a recommendation to refinance this student loan 1114 is recorded. Note that it is fully anticipated that there are multiple student loans, and each student loan will be considered either separately (e.g. individual refinanced student loans) or combined in any order into one or more refinanced student loans.

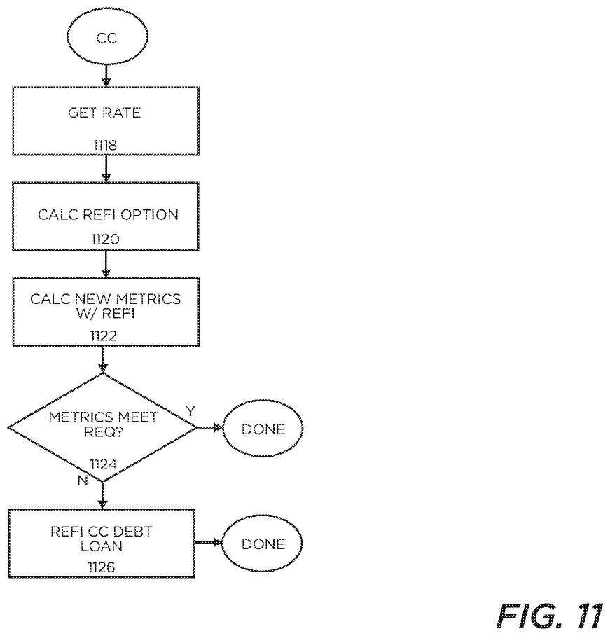

In the example shown in FIG. 11, it has been determined that there is some credit card balance (debt). Credit card debt usually carries high interest rates that result in high monthly payments. The credit card debt is processed by finding a new, lower, credit card rate from a lender 1118. For example, some lenders have credit cards that will accept balance transfers at a lower interest rate than the entity's existing credit card(s) or some lenders will map the credit card debt into a different type of loan, etc. A calculation is made 1120 to determine the effect of the refinanced credit card as well as a calculation 1122 of the new risk metrics taking into consideration the refinanced credit card debt. If the new risk metrics still do not meet the requirements 1124, no benefit can be obtained from refinancing the credit card debt and no solution is recorded. If the new risk meets the requirements 1124, a recommendation to refinance some or all of the credit card debt 1126 is recorded.

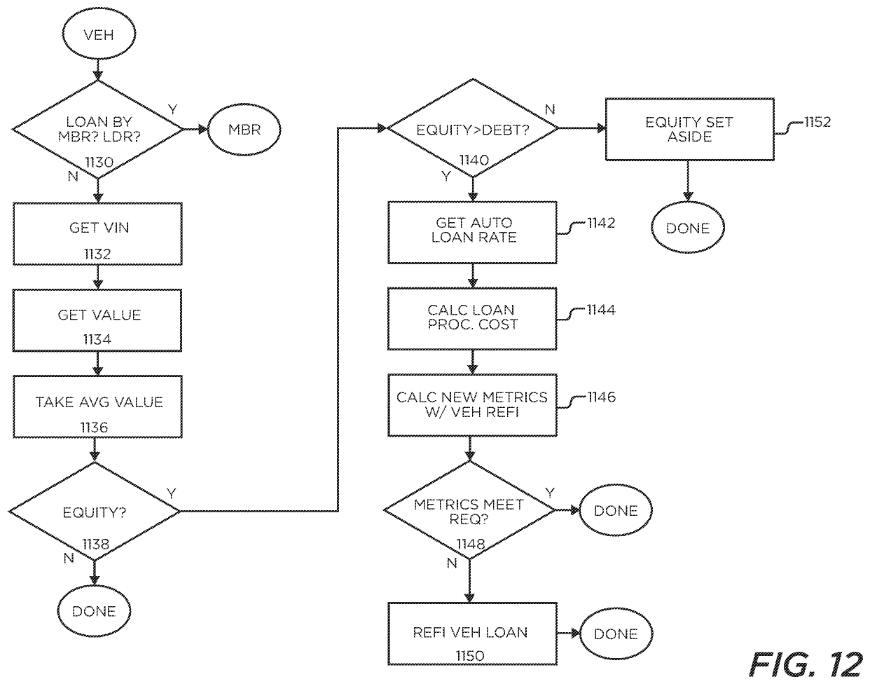

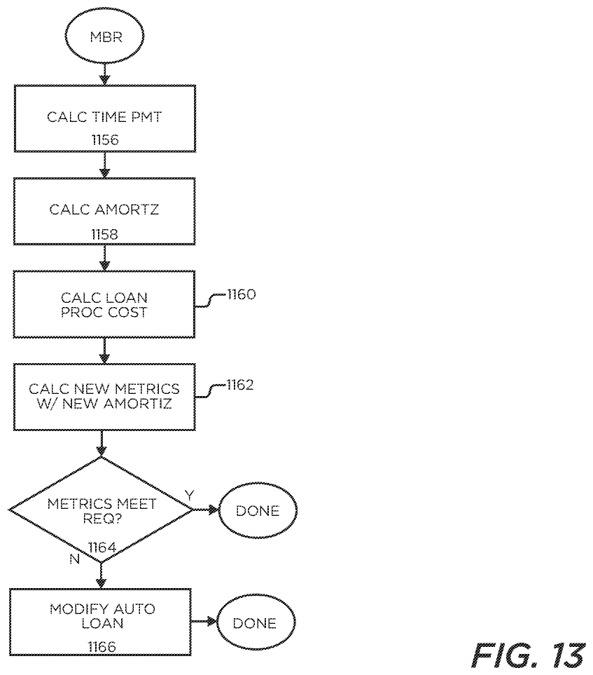

In the example shown in FIGS. 12 and 13, it has been determined that there is at least one vehicle loan. A vehicle loan is typically for a motor vehicle such as a car, truck, motorcycle, etc. It is also anticipated that other vehicles be reviewed such as boats, airplanes, etc., though different tools are available to ascertain the current value of such. For example, instead of using a Kelly Blue Book value for an auto, a boat trader value is used for a boat. Again, in countries other than the United States, it is fully anticipated that other service provides similar information regarding the current value of such vehicles, etc.

The vehicle loan(s) is/are processed first by determining if the existing vehicle loan was made by a member lending institution 1130 (or the lending institution that is running the recommendation engine). If the existing vehicle loan was made by a member lending institution 1130, the vehicle loan is processed differently as in FIG. 13.

If the existing vehicle loan was not made by a member lending institution 1130, the vehicle identification number is obtained 1132 (e.g. from the title or from the original loan). The vehicle identification number (VIN) is useful in determining what options are included with the vehicle, etc. If not available, the value of the vehicle s estimated using further inputs by the user. Also, the condition of the vehicle must be estimated, as a poorly maintained vehicle is worth less than a well-maintained vehicle.

Now, the value of the vehicle is determined 1134 through the use of the plurality of data sources 1006/1008/1010/1012/1014. The valuation(s) are then averaged 1136 and it is determined if there is equity 1138 in the vehicle (e.g. the average value calculated is greater than the current vehicle loan). If there is no equity 1138 in the vehicle, no alternative is reported, and this search is done.

If there is equity 1138 in the vehicle, but the equity is not greater than the debt 1140, equity set aside 1152 is possible. In this, the lender allows a certain percentage of the equity to be borrowed against.

If the equity is not greater than the debt 1140, an auto loan rate is obtained from a lender 1142 and the loan processing costs are calculated 1144. Both are used to calculate the new risk metrics 1146 related to the vehicle refinancing. If the new risk metrics do not meet the loan requirements 1148, refinancing of the vehicle does not help and this search is done. If the new risk metrics do meet the loan requirements, a recommendation to refinance the vehicle is recorded 1150.

When the lender is a member (or the loan originator), it is in the lender's interest to amortize the vehicle loan over a different time period, keeping all other terms of the vehicle loan the same. For example, if the value of the vehicle is determined to be $25,000.00 and the amount owed is $20,000.00, many lenders allow re-amortization allowing the payments to be spread out over a different time period or allowing for a one-time payment that will reduce the monthly payments. Without such a feature, paying extra principle would not change the monthly payments, it would only shorten the number of payments and make payoff occur earlier.

When the lender is a member (or the loan originator), a new time payment of the loan is calculated 1156, the amortization is calculated 1158 and the cost for processing the loan is calculated 1160. New risk metrics with the new amortization schedule are calculated 1162. If the new risk metrics do not meet the product requirements for the loan 1164, amortization of the vehicle over a new period of time does not help and this search is done. If the new risk metrics are within the product requirements for the loan 1164, a recommendation to modify the amortization of the loan on the vehicle is recorded 1166.

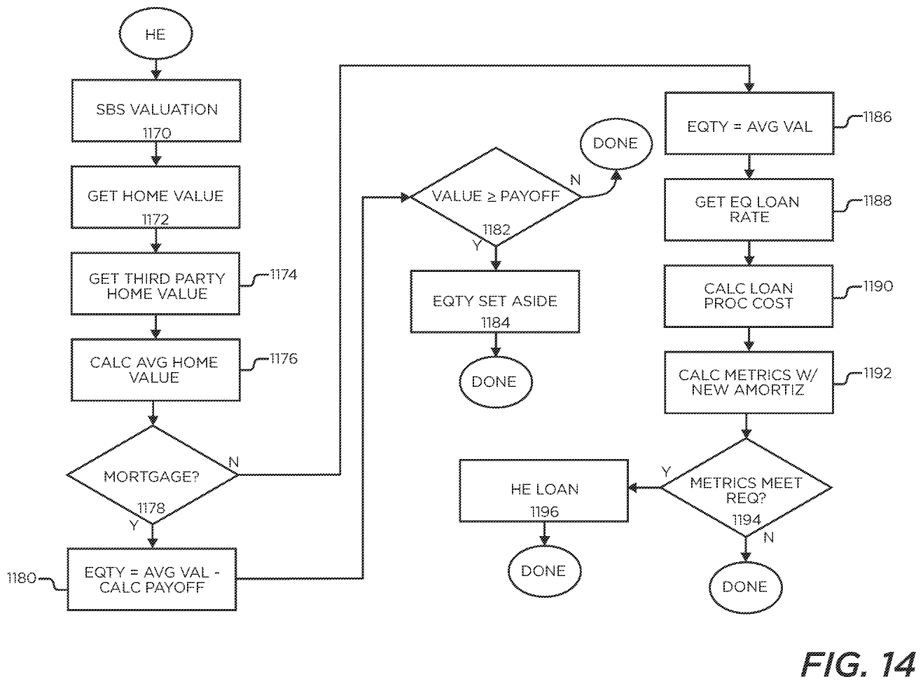

In the example shown in FIG. 14, it has been determined that there is at least some home equity that can be used to improve the entity's financial position, for example, the entity's debt-to-income ratio. The home equity is processed by obtaining one or more valuations for the property. For example, in the United States, a Select Business Service (SBS) valuation of the home is obtained 1170, a Fannie Mae valuation of the home is obtained 1172 (e.g. using the Fannie Mae home value explorer (HVE)), and a third-party value of the home 1174. An average value of the home is calculated 1176 from the above. If there is no mortgage 1178, then the equity equals this average value 1186.

If the entity has a mortgage 1178, then the equity equals this average value minus a calculated payoff for the mortgage 1180 and a test 1182 is made to determine if the equity is greater than the amount which is required to pay off the mortgage. If the test 1182 indicates that the equity is greater than the amount which is required to pay off the mortgage, then the recommendation is for equity set aside 1184.

If there is no mortgage 1178 or the test 1182 indicates that the equity is not greater than the amount which is required to pay off the mortgage, then a home equity loan rate is obtained from a lender 1188 and the loan processing costs are calculated 1190 and new risk metrics are calculated 1192 including the additional payments required for the home equity loan, and applying the loan amount to other loans or to the down payment, etc. For example, if the entity owns a home that is worth $220,000.00 and they owe $150,000.00, then there is roughly $70,000.00 in equity that the entity can take out as a home equity loan and this $70,000.00 is usable to pay off or pay down credit card debt, pay off or pay down other loans, and/or pay off or pay down other debt such as back taxes.

If the risk metrics fall within the product requirements for the primary loan 1194, a recommendation to obtain the home equity loan is recorded 1196. As an example, the proceeds from the home equity loan are used for paying off or paying down credit card debt, paying off or paying down a loan (e.g. an auto loan).

Referring to FIG. 15, options 1202/1204/1206/1236/1238/1240 10 for each liability are generated from the application data provided by the entity. These preliminary options are generated respective to tradelines 1200/1234 based on which tradeline the application data has been passed through and its criteria. The options are then discarded or combined using the product requirements 1208/1210/1212/1242/1244/1246 defined for the respective product. The options that were considered are then consolidated into the final options 1214/1248 that will pass through high pass filter. A description of the filter follows.

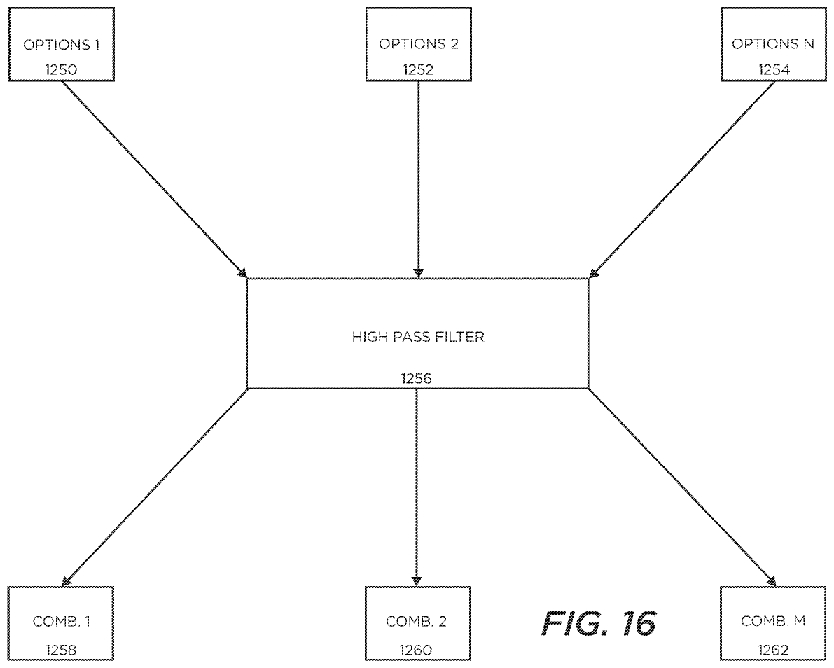

Referring to FIG. 16, once the options for each liability are generated, a statistical model is used to rate each option according to the results of previous recommendations. This preliminary scoring system embodies the factors described in FIGS. 3-6. Once each option is properly scored 1250/1252/1254, a high pass filter 1256 is applied on those ratings to remove options that provide little to no value in improving the financial situation of the applicant. At the end of this process, the options are combined 1258/1260/1262 into the following M combinations:

$${{\prod }^{N}}_{i = 1} {x}_{i}$$

Where xi indicates the number of refinancing options for each of the N tradelines.

In the simplified entity above, the credit card debt may have 100 different refinancing options, the student loan debt may have 50, and a mortgage may have 200. In this case, the total number of ways to choose one refinancing option from each tradeline and combine them is:

100*50*200=1,000,000 combinations

In this embodiment, the solution engine is used to provide suggestion(s) regarding the entity's financial profile to move the entities financial profile into alignment with the requirements of the loan being sought. In this case, further filtering is needed to limit the combinations to only the scenarios that meet the requirements of the loan being sought. If no solution exists that fulfills the requirements, suggestions are still made to improve the financial situation of the entity.

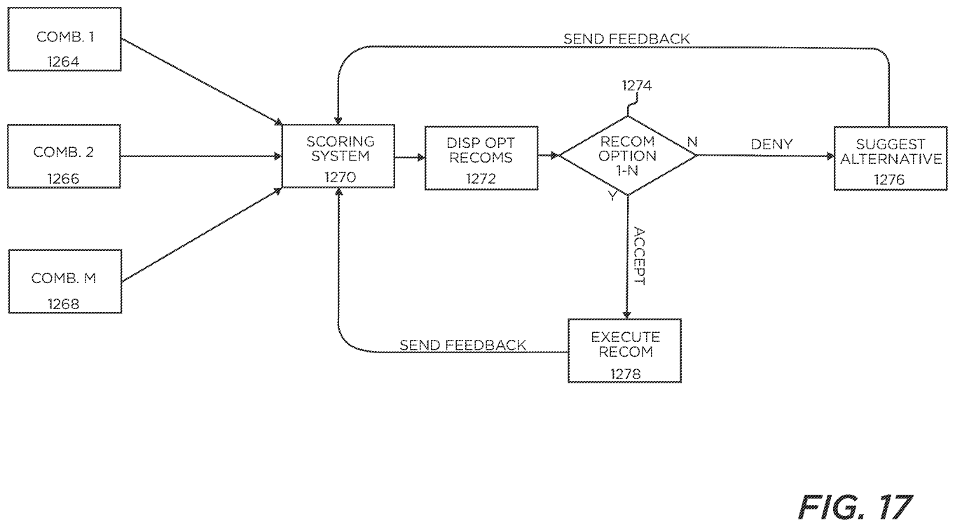

Using the factors in FIGS. 3, 3A, and 4-6 and the newly combined refinancing options 1258/1260/1262, the algorithm calculates a score using a statistical model derived from historical data (see scoring system 1270 of FIG. 17). The combination with the highest score(s) is then displayed/printed 1272 to the user for validation and acceptance. If the entity accepts the combination of refinancing recommendations, the entity then completes the list of steps in accordance with the displayed/printed recommendations to move the entity's financial profile in a positive direction to improve qualifications for the loan being sought.

In cases where the entity attempts to implement the recommendation, but cannot or does not, a feedback detection system is used to identify that the recommendation that failed and a data point is captured for improvement of further models. Anticipated reasons for failure include, for example, failures within the system such as data inaccuracy or unforeseen issues that occur after a report is generated such as a loss of the entity's employment. Independent of the reason, the feedback systems capture the event (data point) and records the event for use within the scoring models. In some embodiments, the feedback detection system is a manual feedback system in which the entity or user notifies the of the failure and this data is inputted to capture the event. In some embodiments, the feedback detection system is an automated detection system that uses captured metadata on the entity to determine that a failure event has occurred.

An example of the manual feedback detection is when the entity denies a recommendation as in FIG. 17. Referring to FIG. 17, combinations of options 1264/1266/1268 as generated in FIG. 16 are passed through a scoring system 1270 in order to generate the optimal recommendations 1274. As an example the scoring system identifies this preference and as a result weighs the impact of future solutions that reduce total interest more heavily than solutions which do not reduce total interest.

If recommendations are denied by the entity, they then provide a rejection reason and resubmit the data for reprocessing. Alternatives are suggested 1276, and the process of FIG. 17 repeats indefinitely until an acceptable solution is reached or there are no further solutions available. Each time the entity denies a recommendation, a record is made of the event and the scoring system is updated. Once a solution is reached, a record of that event is sent to the scoring system for use as positive feedback for the accepted recommendations 1278.

Another example of the automated feedback system is telemetry captured from the user's computing device that provides insights into the actions taken by that user such as idling on a web page for a long time or navigating away from a recommendation without indicating it was successful.

In addition to the recommendation feedback, in some embodiments the models leverage the current and historical financial profile of the entity to better understand that entity's financial goals. Using the entity's financial profile data detailed in FIGS. 3, 3A, and 4-6 and optional user input, data on the reported or inferred financial goals of the individual is fed into the scoring system indicating which solutions are best for that entity. For example, if a person reports to the system that they prioritize paying the least amount of total interest possible on their debts, then this priority is captured and used as input data for the scoring system. The scoring system identifies this preference and weighs the impact of solutions that reduce total interest more heavily solutions that do not reduce total interest.

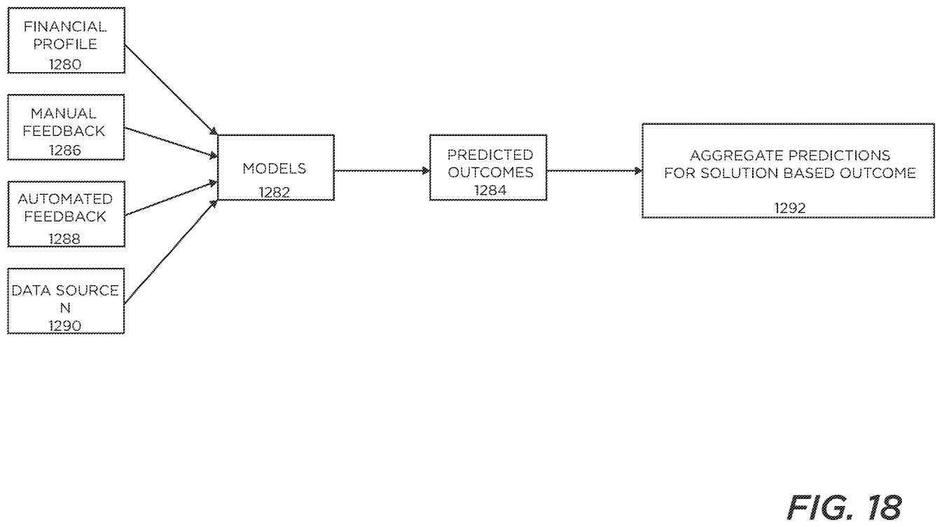

The scoring system, FIG. 18, utilizes machine learned models to find the optimal score for each combination for that individual. These models can be generated using either supervised or unsupervised algorithms which can consist of but are not limited to k-nearest neighbor algorithms, linear regression algorithms, decision tree algorithms, and or support vector machine algorithms.

The models are trained from sets of a master dataset which is a collection of all feedback data and the parameters which resulted in that data. Depending on use case, the models can be trained with subsets of the training data or all the training data. Each combination in the scoring system is fed into the trained models and an aggregated score is resolved. Depending on use cases the combination can be fed into none or all, or any combination of the models there within. If no models are queried with the combination, there is a base score that each combination has that can be used instead. This resulting score is used to find the optimal recommendations.

Note that as stated previously, in this program flow, an example of a home loan, e.g. a mortgage is used in the examples shown. There is no limitation as to the type and purpose of loan that is envisioned to be originated by the disclosed system and method. For example, types of loans include, but are not limited to, vehicle loans, boat loans, personal loans, loans for jewelry, etc.

The described invention and all equivalents are understood to be used by a lender (e.g. a certain bank uses the system to originate loans), by a third party that originates loans for several lenders, or as a tool that is used by the entity directly (the entity becomes the user of the recommendation engine). Compensation from usage of the tool varies. For example, if used by a lender, compensation is provided as a percentage of loans that result from issues solved by the system for loan origination. If used by a third party, the lender that is used compensates the third party and the third party either pays a flat monthly fee for usage of the system for loan origination or pays a percentage of what is earned from the lenders. When used by the entity (e.g. internet based), in some embodiments, compensation is derived from advertisements (e.g. for homeowner's insurance, title insurance, etc.) and/or compensation is provided from preferred lenders that provide the desired loan and/or alternative solutions (e.g. a reduced rate vehicle loan). When used directly by the entity, the entity either pays a fee, and/or income is derived from advertising.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of creating financial recommendations using a recommendation engine, the method comprising:
obtaining data regarding a desired loan for an entity, the data including a loan amount;
obtaining financial data for the entity;
obtaining a credit report for the entity;
obtaining a set of instruments that are currently available from institutions;
if a debt-to-income ratio of the entity for the desired loan is less than a maximum debt-to-income ratio, approving the desired loan;
otherwise, generating a plurality of financial recommendations for the entity using the financial data, the credit report, and the set of instruments;
sorting the plurality of financial recommendations into a set of top financial recommendations; and
for each recommendation in the set of the top financial recommendations, if applying a current one of the set of the top financial recommendation reduces the debt-to-income ratio for the desired loan to less than the maximum debt-to-income ratio, suggesting the current one of the set of the top financial recommendation to the entity, and if the entity accepts and implements any recommendation, approving the desired loan.

2. The method of claim 1, wherein after the step of if the debt-to-income ratio of the desired loan is less than the maximum debt-to-income ratio, approving the desired loan:
generating the plurality of financial recommendations for the entity using the financial data, the credit report, and the set of instruments;
sorting the plurality of financial recommendations into a set of the top financial recommendations; and
suggesting the set of the top financial recommendations to the entity for improving finances of the entity.

3. The method of claim 1, wherein the step of generating the plurality of financial recommendations for the entity comprises analyzing credit card debt of the entity and searching for an alternative credit card that results in reducing a monthly payment by the entity.

4. The method of claim 1, wherein the step of generating the plurality of financial recommendations for the entity comprises analyzing student loan debt of the entity and searching for an alternative loan that results in reducing a monthly payment by the entity.

5. The method of claim 1, wherein the step of generating the plurality of financial recommendations for the entity comprises analyzing at least one vehicle loan of the entity and including an alternative solution that is a loan that results in reducing a monthly payment by the entity.

6. The method of claim 5, wherein if one vehicle loan of the at least one vehicle loan is from a member lender, including the alternative solution that re-amortizes the one vehicle loan with terms that will reduce the monthly payment by the entity.

7. The method of claim 1, wherein the step of generating the plurality of financial recommendations for the entity comprises analyzing an equity in a property owned by the entity and if there is equity in the property owned by the entity, including an alternative solution that includes use of the equity to improve the debt-to-income ratio of the entity.

8. The method of claim 1, wherein the desired loan is a mortgage.

9. The method of claim 1, wherein the entity comprises two or more co-entities.

10. The method of claim 9, wherein the step of generating the plurality of financial recommendations for the entity comprises separately analyzing the debt-to-income ratio for each of the two or more co-entities.

11. A system for making financial recommendations, the system comprising:
a computer;
a plurality of data sources that are accessible by the computer, the plurality of data sources comprising a credit reporting agency and a lender;
software running on the computer receives financial data regarding an entity and stores the financial data in a memory of the computer, the financial data is from the entity and/or from any or all of the data sources;
the software running on the computer receives data regarding a desired loan and stores the data regarding the desired loan, the data regarding the desired loan comprising a loan amount;
the software running on the computer calculates a debt-to-income ratio for the entity from the financial data and the data regarding the desired loan;
if debt-to-income ratio for the entity is less than a maximum debt-to-income ratio, the software provides approval for the desired loan and ends;
otherwise, the software generates alternative solutions that will reduce the debt-to-income ratio to a value that is less than the maximum debt-to-income ratio;
if there are no alternative solutions that reduce the debt-to-income ratio to the value that is less than the maximum debt-to-income ratio, the software rejects the desired loan and ends;
the software sorts the alternative solutions into a list of recommended alternative solutions and reports the recommended alternative solutions that best improve the debt-to-income ratio and the software presents the list of recommended alternative solutions to the entity;
if the entity accepts and implements one of the recommended alternative solutions from the list of recommended alternative solutions, the software approves the desired loan and ends; and
if the entity rejects the alternative solutions, the software denies the desired loan and ends.

12. The system of claim 11, wherein the step of approving the desired loan without requiring the alternative solutions further comprises:
the software generates the alternative solutions that will reduce the debt-to-income ratio to the value that is less than the maximum debt-to-income ratio; and
the software sorts the alternative solutions and reports the alternative solutions that best improve a financial position of the entity.

13. The system of claim 11, wherein when the software generates the alternative solutions, the software analyzes credit card debt and the software includes a solution of refinancing the credit card debt with terms that will reduce a monthly payment in the alternative solutions.

14. The system of claim 11, wherein when the software generates the alternative solutions that will reduce the debt-to-income ratio to the value that is less than the maximum debt-to-income ratio, the software analyzes student loan debt of the entity and the software includes an alternative solution of refinancing the student loan debt with terms that will reduce a monthly payment by the entity.

15. The system of claim 11, wherein when the software generates the alternative solutions that will reduce the debt-to-income ratio to the value that is less than the maximum debt-to-income ratio, the software finds a vehicle loan of the entity and the software includes an alternative solution of refinancing the vehicle loan with terms that will reduce a monthly payment by the entity.

16. The system of claim 15, wherein if the vehicle loan is from a member lender, the software includes the alternative solution of re-amortization of the vehicle loan with the terms that will reduce the monthly payment by the entity.

17. The system of claim 11, wherein when the software generates the alternative solutions that will reduce the debt-to-income ratio to the value that is less than the maximum debt-to-income ratio, the software analyzes an equity in a property owned by the entity and if there is the equity in the property owned by the entity, the software includes an alternative solution of use of the equity to improve the debt-to-income ratio.

18. The system of claim 11, wherein when the software generates the alternative solutions that will reduce the debt-to-income ratio to the value that is less than the maximum debt-to-income ratio, the software analyzes a cash equity owned by the entity and allocates the cash equity in increments to existing loans of the entity to generate one or more alternative solutions that include paying down one or more of the existing loans of the entity.

19. A system for making financial recommendations, the system comprising:
a computer;
a plurality of data sources that are accessible by the computer, the plurality of data sources comprising a credit reporting agency and a lender;
software running on the computer receives financial data regarding an entity and stores the financial data in a memory of the computer, the financial data is from the entity and/or from any or all of the plurality of data sources;
the software generates a set of alternative solutions that will improve finances of the entity; and
the software sorts the set of the alternative solutions and reports a subset of the set of the alternative solutions that best improves the finances of the entity.

20. The system of claim 19, wherein the software sorts the set of the alternative solutions and reports the set of the alternative solutions that best improve a debt-to-income of the entity.
